(19) United States
(12) Patent Application Publication
(10) Pub. No.: US 2011/0307286 A1
(43) Pub. Date: Dec. 15, 2011

(54) SCHEDULING A MEETING BETWEEN DIFFERENT WORK SCHEDULES

(75) Inventors: Thomas Richard Haynes, Apex, NC (US); Lin Sun, Morrisville, NC (US)

(73) Assignee: International Business Machines Corporation, Armonk, NY (US)

(21) Appl. No.: 12/814,984

(22) Filed: Jun. 14, 2010

(51) Int. Cl. G06Q 10/00; G06F 15/16

(52) U.S. Cl. 705/7.19; 709/206

(57) ABSTRACT

A method of scheduling a meeting, with computing systems in communication with a data network, includes: storing an identification of a prospective meeting participant's regular work hours and typically-worked off-work hours on a memory device of a computing system; and with the computing system, generating a suggested meeting time within the regular work hours and typically-worked off-work hours. A system for scheduling a meeting includes: a computing system programmed to store an identification of a prospective meeting participant's regular work hours and typically-worked off-work hours on a memory device for use by meeting scheduling software, also stored on the memory device, for generating a suggested meeting time within the regular work hours and typically-worked off-work hours.

### BACKGROUND

Aspects of the present invention relate in general to applications and solutions for scheduling meetings, and more particularly, to a system and method for scheduling meetings between persons having different work schedules.

Throughout the course of business, people often schedule meetings with persons both within and outside of their own organization. Although such meetings may be in person, in many cases, these meetings are conducted over the telephone or by video or web-conferencing.

Most people have a defined work schedule, i.e., hours on particular days of the week when that person is typically working or is required to be working. If meeting participants are in the same general location, they may tend to have the same general work schedule. However, meetings are often needed between people having different work schedules. For example, if a meeting organizer wishes to schedule a meeting with a person in a different part of the world than he or she currently resides, that meeting organizer will need to take into account the work schedule difference caused by participants being in different time zones.

In some cases, the time zone discrepancy may be a minor issue. For example, a person on the East coast of the United States may wish to schedule a meeting with a person in Europe. There is generally only a five to six hour time difference between these two locations. Thus, a meeting may be scheduled at a time when it is morning for the person in the United States and afternoon for the person in Europe. Both of these times are generally during normal business hours and, thus, not problematic.

However, there may be some cases when a meeting organizer wishes to schedule a meeting with someone who has a work schedule that has no overlap of regular working hours with the work schedule of the meeting organizer. This may be the case if, for example, the meeting is to be scheduled between a participant in the United States and a participant in China. As there is no overlap of regular work hours for those participants, it may be more difficult to schedule a meeting at a time when both participants will be conveniently available.

### BRIEF SUMMARY

A method of scheduling a meeting, with computing systems in communication with a data network, includes: storing an identification of a prospective meeting participant's regular work hours and typically-worked off-work hours on a memory device of a computing system; and with the computing system, generating a suggested meeting time within the regular work hours and typically-worked off-work hours.

A system for scheduling a meeting includes: a computing system programmed to store an identification of a prospective meeting participant's regular work hours and typically-worked off-work hours on a memory device for use by meeting scheduling software, also stored on the memory device, for generating a suggested meeting time within the regular work hours and typically-worked off-work hours.

A computer program product for scheduling a meeting includes a computer readable storage medium having computer readable code embodied therewith, the computer readable program code comprising: computer readable program code configured to store an identification of a prospective meeting participant's regular work hours and typically-worked off-work hours; and computer readable program code configured to generate a suggested meeting time within the regular work hours and typically-worked off-work hours.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system which may be used to schedule meetings across different work schedules, according to one embodiment of principles described herein.

FIG. 2 is a diagram showing an illustrative process for scheduling a meeting across different work schedules, according to one embodiment of principles described herein.

FIG. 3 is a diagram showing an illustrative work schedule comparison chart, according to one embodiment of principles described herein.

FIG. 4 is a diagram showing an illustrative user interface for scheduling a meeting across different work schedules, according to one embodiment of principles described herein.

FIG. 5 is a flowchart showing an illustrative method for scheduling a meeting across different work schedules, according to one embodiment of principles described herein.

Throughout the drawings, identical reference numbers designate similar, but not necessarily identical, elements.

### DETAILED DESCRIPTION

The present specification discloses a method and system for scheduling a meeting between persons having different work schedules. According to certain illustrative embodiments, a computing system may be configured to maintain a record of a user's regular work hours. Additionally, the computing system may be configured to record and analyze its user's usage statistics during off-work hours that are outside the user's regular work schedule. For example, many people log on to a company network from home outside their regular work schedule. During such access, they may use email, instant messaging or other company resources. The computing system, in such an example, may be configured to determine on what days of the week and at what hours a user typically works outside of his or her regularly scheduled work hours.

If a meeting request involves at least two participants with no overlap in their regular work schedules, computing system involved in scheduling the meeting may determine if there is any overlap between the work schedule of a first participant and the commonly worked off-work hours of a second participant during which a relatively convenient meeting could be scheduled. For example, a prospective meeting participant may typically do a little work between 9:00 PM and 10:00 PM on weeknights. When trying to schedule a meeting with that participant, if there is no overlap with some other participant's regular work hours, it may be the case that the other participant's regular work hours include the 9:00 PM to 10:00 PM hour typically worked by the first participant. In such a case, the system described herein can suggest a meeting during that time period which would be relatively convenient for both meeting participants. While here described in terms of only two meeting participants, these principles can be applied to schedule a meeting among any number of participants.

Through use of a system or method embodying principles described herein, users may be able to more easily schedule meetings with those having a work schedule that does not overlap with their own. By being aware of the typically-worked off-work hours by a prospective meeting participant, the method or application described herein has a broader range of times during which a meeting may be scheduled to the mutual convenience of participants in different locations or with otherwise different work schedules.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device; or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN); or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout this specification and in the appended claims, the term “regular work hours” or “regular work schedule” is to be broadly interpreted as an individual's regularly scheduled work time. For example, this may be the hours during which the individual is required to report for work by an employer, the hours the individual advertises as being available to clients, or the hours generally considered as business hours in the location where the individual works. For example, an individual may regularly work from 9:00 AM to 5:00 PM. An individual's regular work hours or work schedule may vary with the day of the week.

The term “off-work hours” is to be broadly interpreted as any time outside of an individual's regularly scheduled hours or regular work schedule. As noted above, even though not part of an individual's regularly scheduled work time, some off-work hours may be still a time during which an individual chooses to perform some work duties.

The term “typically-worked off-work hours” is to be broadly interpreted as referring to those off-work hours that a worker engages in work related activities on a voluntary basis. As described herein, different standards may be applied to determine if an off-work hour is worked frequently enough to be considered as a typically-worked off-work hour.

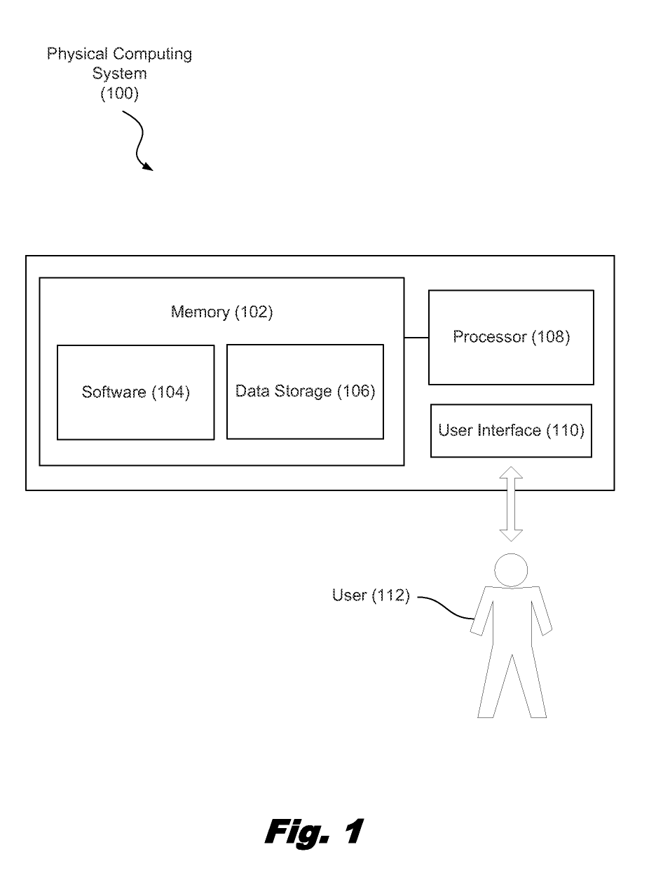

Referring now to the figures, FIG. 1 is a diagram showing an illustrative physical computing system (100) which may be used to schedule meetings among participants with different work schedules. According to certain illustrative embodiments, the physical computing system (100) may include a memory (102) having software (104) and data (106) stored thereon. As described below, this software (104) will include meeting scheduling and calendaring software.

There are many types of memory available. Some types of memory, such as hard disk drives, optical disc drives, and solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) in the memory (102). The physical computing system (100) may be embodied as a variety of physical computing devices including, but not limited to, a laptop or tablet computer, a desktop computer, and a Personal Digital Assistant (PDA) or mobile smart phone.

Various types of software (106) may be utilized by the physical computing system (100). For example, one type of software which may be stored in memory is meeting management software. The meeting management software is a program configured to assist a user (112) with the task of managing his or her meeting and appointment schedule. The meeting management software may operate by maintaining a record of a user's schedule and placing meeting entries in the schedule at times when the user (112) has scheduled a meeting. The meeting management software may be configured to interface with meeting management software on the computing systems of other users to facilitate the scheduling of meetings among those users.

A user interface (110) may provide a means for the user (112) to interact with the computing system (100). The user interface may include any collection of devices for interfacing with a human user (112). For example, the user interface (110) may include an output component such as a display device and input components such as a mouse or keyboard. Information associated with calendar entries, including meeting entries, may be displayed to the user (112) on a display device of the user interface (110). Instructions from the user to the physical computing system (100) may be received through the input devices of the user interface (110).

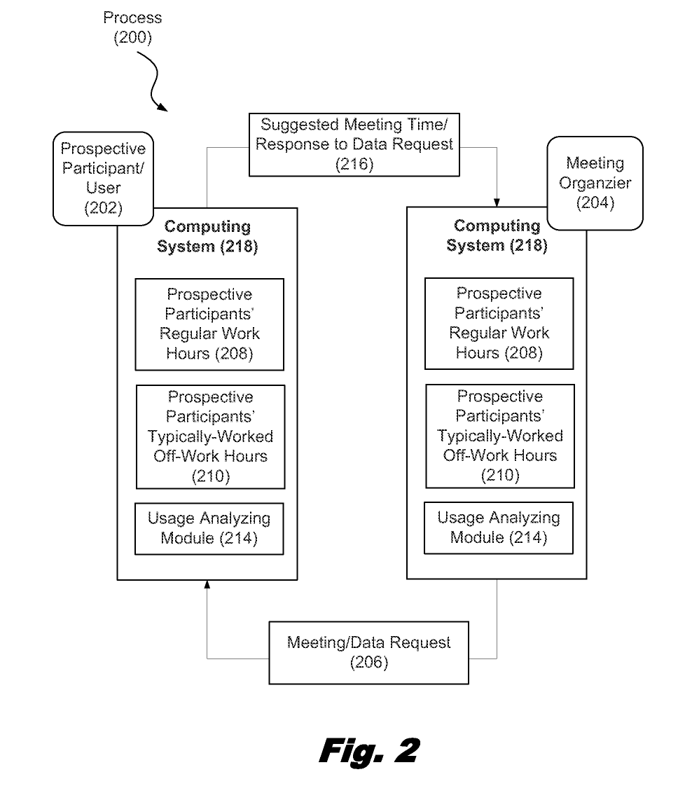

FIG. 2 is a diagram showing an illustrative process (200) for using the computing system of FIG. 1 for scheduling a meeting among participants with different work schedules. Referring to FIG. 2, a meeting organizer (204) is the party or entity that attempts to schedule a meeting. The meeting organizer (204) may be, for example, a huma participant to the meeting, a human tasked with organizing the meeting although not participating, or an automated system programmed to organize the meeting.

In the illustrated example, the meeting organizer (204) may initiate a meeting request (206). This meeting request (206) is then transmitted from the computing system of the meeting organizer (206) to the computing system of each prospective participant (202). The transmission of the meeting request (206) is conducted over a computer network, for example, an intranet or the Internet. It will be understood that there may be any number of prospective huma participants (202) among whom the meeting is being scheduled.

The computing system (218) illustrated in FIG. 2 may be the personal computing system of either the meeting organizer or a prospective participant or a networked server communicating with the personal computers of the various meeting participants and organizer. The meeting request (206) will be processed by the computing systems (218) as described below. The processing of the meeting request (206) described here may be conducted either by the meeting organizer's computer before the request (206) is transmitted or by the computer of a prospective participant after the request (206) is received. Typically, the meeting request (206) will be issued by the computing system of the meeting organizer and processed by the computing systems belong to each of the prospective participants, although anyone may serve as the meeting organizer.

As described in further detail below, the computing system (218) will have or obtain a record of the regular work hours (208) for at least one, perhaps all, of the prospective participants of the meeting. With respect to the user of that computing system, the computing system (218) may receive the data specifying the user's regular work hours (208) directly from the user (202). For example, the user (202) may manually enter in his or her regular work hours (208). Alternatively, the computing system (218) may receive the user's regular work hours (208) from another individual such as the user's supervisor. As a default, the computing system (218) may presume that 9 AM to 5 PM in the location of the computing system (218) are the regular work hours of the user.

If needed, the computing system (218) will also have or obtain a record of the typically-worked off-work hours by at least one perhaps all of the prospective participants (210) to the requested meeting. For any such information the computer system (218) does not already possess, a request may be sent via a network, such as the Internet, to the computer of a prospective participant for that prospective participant's regular work hours and hours typically worked outside of regular work hours.

If the computing system (218) belongs to the meeting organizer, the computing system (218) will use this information to propose a meeting time (216) that can be suggested in the meeting request (206) to the participants. If the computing system (218) belongs to an invited participant, it may use this information to counter-propose a meeting time (216) in response to a meeting request (206) from a meeting organizer (204) with an unacceptable proposed time.

The computing system (218) may also include a usage analyzing module (214) to determine the typically-worked off-work hours (210) of the person whose computing system it is. For example, the usage analyzing module (214) will note the times outside of regular work hours that the user of that computing system (218) has logged onto the system and is using resources typically used for work, such as email, virtual private network, company website, etc.

The usage analyzing module (214) will then determine any pattern by hours and, in some embodiments, day of the week that indicates a habit of the user to work outside of that user's regular work schedule. For example, the usage analyzing module (214) may determine that 70% of the time, the user is on the computer from 9 PM to 10 PM in the evening accessing resources designated as work-related. From this pattern, 9 PM to 10 PM weeknights is added to the typically-worked off-work hours (210) for that user. In another example, the usage analyzing module (214) may determine that 80% of the time, the user of the computing system (218) accesses work-related resources on Monday from 6 PM to 7 PM and on Thursdays from 11 PM to 12 AM. Accordingly, these times are added to the typically-worked off-work hours (210) for that user.

Those resources considered as work-related for purposes of determining typically-worked off-work hours may be designated as best suits a particular application. For example, the resources considered as work-related for purposes of determining typically-worked off-work hours may be determined by the user of the computing system (218), by default settings or by an organization to which the user belongs.

The percentage threshold at which a time of day and day of the week is worked often enough to qualify as a typically-worked off-work hour may also be set by default, by the user or by a relevant organization as best suits a particular application. Alternatively, the computer's user may simply specify off-work hours that should be considered as hours the user is available for work, i.e., typically-worked off-work hours.

Thus, any computing system (218) according to principles disclosed herein will store an indication of the regular work hours for its own user and will determine and store typically-worked off-work hours for its own user. The computing system (218) may also obtain this information for other prospective meeting participants by request the computing system of those prospective meeting participants.

This information, once collected from other parties, may be retained for continuing reference. For example, the computing system (218) may store a list or database of contacts. For some or all of the contacts listed, the computing system (218) may also store a record of that person's regular work hours (208) and/or typically-worked off-work hours (210). In some cases, the computing system (218) store the work location of a contact, but not yet have data specifying the regular work hours (208) for that contact. In such a case, the computing system (218) may presume, until notified otherwise, that the contact's regular work hours are 9:00 AM to 5:00 PM in whatever time zone that contact resides.

In some embodiments, the computing system (218) of the meeting organizer (204) may include the regular work hours (208) of the meeting organizer and/or the typically-worked off-work hours (201) of the meeting organizer along with a meeting request (206) being sent to any number of prospective meeting participants (202). Similarly, the computing system (218) of a prospective meeting participant (202) may include the regular work hours (208) and/or the typically-worked off-work hours (201) of that prospective participant (202) in a response to a meeting request (206) or a request that precedes a meeting request (206).

A computing system (218) that is preparing to issue a meeting request (206) or processing a received meeting request (206) will first try to find an overlap in the regular work schedules of the prospective meeting participants, including the meeting organizer (204) if participating in the meeting. If no such overlap exists in the regular work schedules, then the computing system (218) may look for an overlap between a regular work schedule and typically-worked off-work hours of the various prospective meeting participants. If such an overlap exists, a suggested meeting time (216) is generated at a time during the overlap.

However, if no overlap can be found at all, the various prospective meeting participants may be notified. One of more of the prospective participants may then need to schedule the meeting at a time not normally worked.

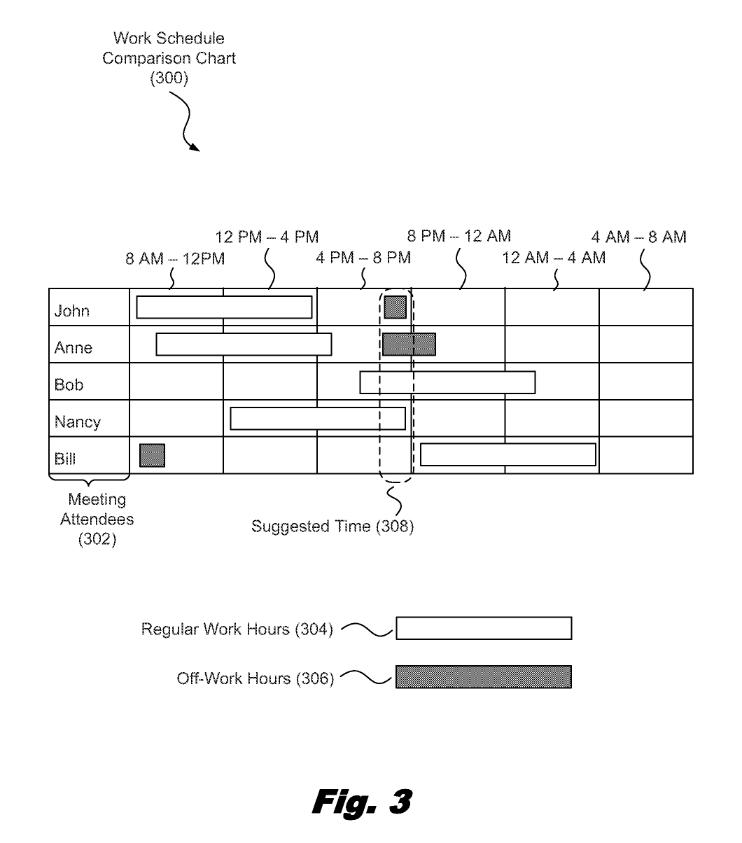

FIG. 3 is a diagram showing an illustrative work schedule comparison chart (300). According to certain illustrative embodiments, a work schedule comparison chart (300) may show the work schedules for a number of prospective meeting participants (302). The displayed work schedule may include both the regular work hours (304) of each prospective participant (302) as well as any typically-worked off-work hours (306) of each participant (302).

The work schedule comparison chart (300) illustrated in FIG. 3 shows the work hours of five prospective meeting participants (302) over a 24 hour period in 4 hour increments. The regular work hours (304) are indicated by the white boxes and the typically-worked off-work hours (206) are indicated by the shaded boxes. For example, John's regular work hours (304) may be scheduled from 8:00 AM to 4:00 PM. Additionally, John may typically spend some time in the evenings between 7:00 PM to 8:00 PM engaged in work-related activities. Likewise, Anne may have regular work hours (304) between 9:00 AM and 5:00 PM and off-work hours (306) between 7:00 PM and 9:00 PM. If John and Anne were the only participants in a meeting, it would not be difficult to schedule a time during both of their regular work hours (304).

However, in some cases, a participant may have a regular work schedule that does not coincide with the work schedule of other participants. For example, as stated in the hours of the local timey zone, Bob may have regular work hours (304) between the hours of 6:00 PM and 2:00 AM. This odd schedule may be because Bob works a night shift. For example, some professions may require employees to work afternoon or night shifts. Thus, Bob may be in the same time zone as John and Anne but work a different shift. Alternatively, this odd schedule may be because Bob is located in a different part of the world with a different time zone. Thus, 6:00 PM to 2:00 AM according to John's time zone may correspond to 9:00 AM to 5:00 PM in whatever time zone Bob is located. Likewise, Nancy may have odd regular work hours (304) compared to John and Anne. This odd work schedule may also be due to Nancy's location or simply a different shift schedule. If John, Anne, Bob, and Nancy were to schedule a meeting with one another, there would be no time in which all of their regular work hours (304) would overlap. However, there is a time in which both John and Anne's typically-worked off-work hours (306) overlap with Bob and Nancy's regular work hours (304). Thus, the time between 7:00 PM and 8:00 PM may be the best suggested time (308) to schedule a meeting between those participants.

If an additional participant, Bill, were to be included in the meeting, there would be no time in which Bill's regular work hours (304) or off-work hours (306) overlap all other meeting participants (302). In such a scenario, the computing system may notify Bill and/or the other participants. Bill may then have to work outside both his regular work hours (304) and typically-worked off-work hours by going into work early to participate in the meeting. Alternatively, Bill may simply opt not to participate in the meeting.

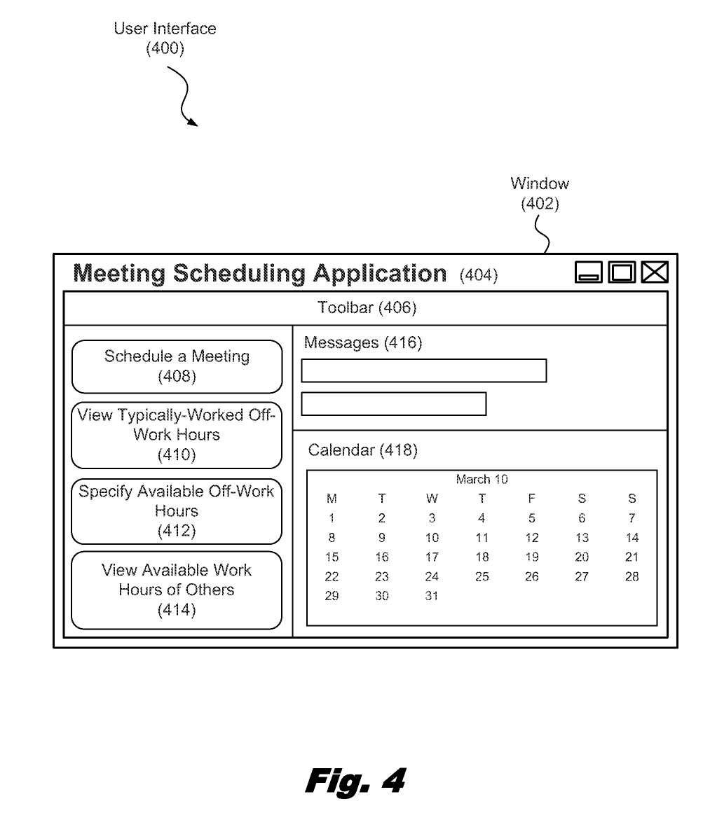

FIG. 4 is a diagram showing an illustrative user interface (400) for scheduling a meeting across different work schedules. According to certain illustrative embodiments, the user interface (400) may include a window (402) configured to allow a user to interact with a meeting scheduling application (404). The window (402) may include a toolbar (406) with controls that allow the user to schedule a meeting (408), view the user's own typically-worked off-work hours (410), specify the user's own available off-work hours (412) and view available work hours of others (414), both regularly scheduled hours and typically-worked off-work hours. The window (402) may also include a region for messages (416) and a calendar display (418).

Through the user interface (400), a user may use the “schedule a meeting” control (408) to initiate a meeting request. The meeting request may be for a meeting involving any number of other prospective participants. Upon using the “schedule a meeting” control (408), the user may be prompted for date, time, and any other information that may be associated with a meeting request. The user may also select a preferred off-hour work time range from the user's known off-work hours at which to schedule the meeting in the event that there is no overlap of regular work hours between the user and other prospective meeting participants.

Through the user interface (400), the user may view his or her own typically-worked off-work hours which the computing system has determined based on usage statistics as described above. Upon using the “view typically-worked off-work hours” control (410), a user may view his or her past usage statistics in a variety of formats. For example, the user may view the cumulative off-work hours worked, or the average time range in which off-work hours are worked.

In some embodiments, a user may manually enter his or her intended typically-worked off-work hours through the user interface (400). The computing system may use the manually entered specification of typically-worked off-work hours either as an alternative to, or in addition to, the hours determined from the past usage statistics. Upon use of the “specify available off-work hours” control (412), a user may be prompted to enter the hours according to a weekly or monthly schedule.

Through the user interface (400), the user may also view the available work hours of others. The available work hours may include both regular work hours and typically-worked off-work hours of other prospective meeting participants. The available work hours of others may be made known through a variety of means. For example, the user may have a contact list which includes the available schedule for each contact. Additionally, the meeting scheduling application (404) may be configured to communicate over a computer network with a meeting scheduling application used by another prospective meeting participant to retrieve that participant's available hours.

Thus, if a user intends to schedule a meeting with another participant, then the user may check beforehand to see if he or she will have to schedule the meeting during off-work hours. Additionally, the user interface (400) may be configured to inform a user of the typically-worked off-work hours of other entities. Thus, the user may be able to determine a likely time for a meeting schedule that works for all invitees.

The window (402) may be configured to display messages (416) to the user regarding the scheduling of the meeting. A message (416) may be, for example, a meeting request from a meeting organizer. A message may also include alerts to a user in response to a user attempting to schedule a meeting with a participant of a different work schedule. For example, if a user requests to schedule a meeting with a participant during the user's regular work hours and the computing system is aware that that particular participant has a work schedule that does not overlap with the user's own work schedule, then the user interface (400) may be configured to inform the user that he or she may have to schedule the meeting outside of his or her regular work hours. A message may also inform a user that the work schedule of the participant for which a meeting request has been initiated is unknown. Thus, the user may be made aware that he or she may have to schedule the meeting during his or her off-work hours.

The window (402) may also display to the user a calendar display (418). The calendar display (418) may show a daily, weekly, or monthly schedule. The user may navigate the calendar display (418) to see upcoming meetings and openings during which to schedule additional meetings if necessary.

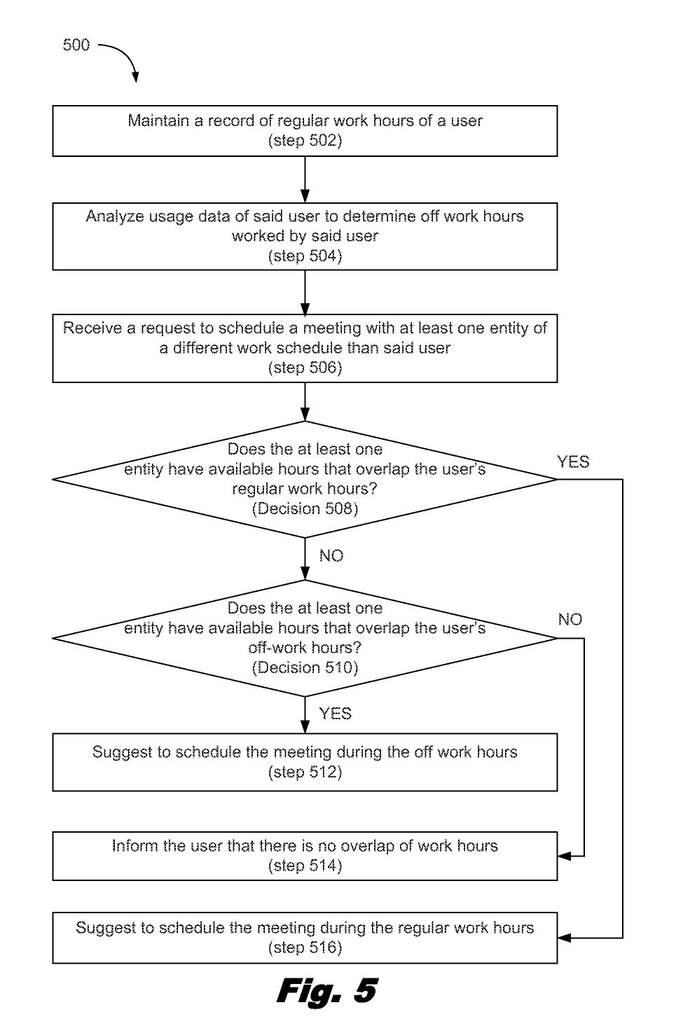

FIG. 5 is a flowchart showing an illustrative method (500) for scheduling a meeting across different work schedules. According to certain illustrative embodiments, the method may include maintaining (step 502) a record of regular work hours of a user; analyzing (step 504) usage data of the user to determine typically-worked off-work hours worked by the user; and receiving (step 506) a request to schedule a meeting with at least one participant of a different work schedule than the user.

It may then be determined (step 508) if the at least one participant has available hours that overlap the user's regular work hours. If it is determined that the at least one participant does indeed (decision 508, YES) have hours that overlap the user's regular work hours, then the method may continue by suggesting (step 516) to schedule the meeting during the user's regular work hours.

If it is determined that the at least one participant does not (decision 508, NO) have hours that overlap the user's regular work hours, then it may be determined (decision 510) if the at least one participant has available hours that overlap the user's typically-worked off-work hours. If it is determined that the at least one participant does indeed (decision 510, YES) have hours that overlap the user's typically-worked off-work hours, then the method (500) may continue by suggesting (step 512) to schedule the meeting during the overlap, i.e., during the user's typically-worked off-work hours.

If it is determined that the at least one participant does not (decision 510, NO) have hours that overlap the user's typically-worked off-work hours, then the method (500) may continue by informing (step 514) the user that there is no overlap of work hours. In such a case, the meeting may have to be scheduled at a less convenient time for one or more prospective participants when those participants are not normally working.

In sum, through use of a system or method embodying principles described herein, users may be able to easily schedule meetings with those having a work schedule that does not overlap with their own. By being aware of the typically-worked off-work hours of a user, the described system may suggest a time that is most likely to be convenient for all participants.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of scheduling a meeting with computing systems in communication with a data network, said method comprising:
storing an identification of a prospective meeting participant's regular work hours and typically-worked off-work hours on a memory device of a computing system; and
with said computing system, generating a suggested meeting time within said regular work hours and typically-worked off-work hours.

2. The method of claim 1, further comprising tracking a user's usage of a said computing system to determine said typically-worked off-work hours for that user when that user is a prospective meeting participant.

3. The method of claim 1, in which generating a suggested meeting time comprises:
comparing said participant's regular work hours and typically-worked off-work hours with those of a second prospective meeting participant; and
placing said suggested meeting time within an overlap of said regular work hours and typically-worked off-work hours of said prospective meeting participant and said second prospective meeting participant.

4. The method of claim 3, further comprising including said suggested meeting time in a meeting request transmitted from a first said computing system to a second said computing system over said data network.

5. The method of claim 3, further comprising generating said suggested meeting time in response to receipt of a meeting request via said data network.

6. The method of claim 3, further comprising informing at least one of said prospective meeting participants if there is no overlap of said regular work hours and typically-worked off-work hours of said prospective meeting participant and said second prospective meeting participant

7. The method of claim 3, further comprising requesting, via said data network, data identifying said regular work hours and typically-worked off-work hours of said second prospective meeting participant from a computing device of said second prospective meeting participant.

8. The method of claim 1, further comprising receiving, through a user interface of said computing system, data specifying said prospective meeting participant's regular work hours and typically-worked off-work hours.

9. The method of claim 1, further comprising transmitting a meeting request with said computing system via said data network, said meeting request including data identifying said prospective meeting participant's regular work hours and typically-worked off-work hours.

10. A system for scheduling a meeting, said system comprising:
a computing system programmed to store an identification of a prospective meeting participant's regular work hours and typically-worked off-work hours on a memory device for use by meeting scheduling software, also stored on said memory device, for generating a suggested meeting time within said regular work hours and typically-worked off-work hours.

11. The system of claim 10, further comprising a usage analyzing module, also stored on said memory device, for tracking a user's usage of a said computing system to determine said typically-worked off-work hours for that user when that user is a prospective meeting participant.

12. The system of claim 10, in which said meeting scheduling software causes said computing system to:
compare said participant's regular work hours and typically-worked off-work hours with those of a second prospective meeting participant; and
place said suggested meeting time within an overlap of said regular work hours and typically-worked off-work hours of said prospective meeting participant and said second prospective meeting participant.

13. The system of claim 12, in which said meeting scheduling software includes said suggested meeting time in a meeting request transmitted from said computing system to a second said computing system over a data network.

14. The system of claim 12, in which said meeting scheduling software generates said suggested meeting time in response to receipt of a meeting request via a data network.

15. The system of claim 12, in which said meeting scheduling software informs at least one of said prospective meeting participants though a user interface if there is no overlap of said regular work hours and typically-worked off-work hours of said prospective meeting participant and said second prospective meeting participant.

16. The system of claim 12, in which said meeting scheduling software requests, via a data network, data identifying said regular work hours and typically-worked off-work hours of said second prospective meeting participant from a computing device of said second prospective meeting participant.

17. The system of claim 10, in which said meeting scheduling software receives, through a user interface of said computing system, data specifying said prospective meeting participant's regular work hours and typically-worked off-work hours.

18. The system of claim 10, in which said meeting scheduling software transmits a meeting request from said computing system via a data network, said meeting request including data identifying said prospective meeting participant's regular work hours and typically-worked off-work hours.

19. A computer program product for scheduling a meeting, said computer program product comprising:
a computer readable storage medium having computer readable code embodied therewith, said computer readable program code comprising:
computer readable program code configured to store an identification of a prospective meeting participant's regular work hours and typically-worked off-work hours; and
computer readable program code configured to generate a suggested meeting time within said regular work hours and typically-worked off-work hours.

20. The computer program product of claim 19, further comprising:
computer readable program code configured to track a user's usage of a said computing system to determine said typically-worked off-work hours for that user when that user is a prospective meeting participant.
